(19) United States
(12) Patent Application Publication
(10) Pub. No.: US 2014/0157151 A1
(43) Pub. Date: Jun. 5, 2014

(54) VIRTUAL DEBATE AND TAGGING SYSTEM AND METHOD

(71) Applicant: Common Sense Exchange, LLC, Rockwall, TX (US)

(72) Inventor: Robert Westmoreland, Rockwall, TX (US)

(21) Appl. No.: 13/911,921

(22) Filed: Jun. 6, 2013

Related U.S. Application Data
(60) Provisional application No. 61/656,107, filed on Jun. 6, 2012.

(51) Int. Cl. H04L 29/06

(52) U.S. Cl. CPC H04L 65/403
USPC 715/753

(57) ABSTRACT

A social network system provides a debate system that allows users to scroll through comments of a particular topic and challenge other users to a virtual debate. The topics may range from political, social, personal, etc. The social networking application collects tags, such as inputs or ratings, of data content with pre-determined categories.

### BACKGROUND OF THE INVENTION

1. Technical Field of the Invention

This invention relates to social networking applications and in particular to systems and methods for implementing an application for multilayer debate and tagging.

2. Description of Related Art

A social networking application system provides a platform for users to interact with other users of the social networking application. The social networking application system is operable for users to create personal profiles, send messages, post comments and blog. Users may join established networks of other users in the social networking application system who share interests or activities. Social network applications, such as Facebook™, Myspace™ and LinkedIn™, have provided people with a different and new method of communication. Social network applications are used regularly by millions of people, and it now seems that social networking will be an enduring part of everyday life.

With the emergence of social networking applications, new innovative applications and features which extend the social networking experience are needed.

### BRIEF DESCRIPTION OF THE SEVERAL VIEWS OF THE DRAWINGS

FIG. 1 is a schematic block diagram of an embodiment of a network system in which the social network application system may operate.

FIG. 2 is a schematic block diagram of an embodiment of a social network application system.

FIG. 3 is a schematic block diagram of an embodiment of a graphical user interface for virtual debate by a social networking application system.

FIG. 4 is a schematic block diagram of another embodiment of a graphical user interface for virtual debate by a social networking application system.

FIG. 5 illustrates a logic flow diagram of an embodiment of a method for providing a comment section GUI by a social networking application.

FIG. 6 illustrates a logic flow diagram of an embodiment of a method for initiating a virtual debate by a social networking application.

FIG. 7 illustrates a logic flow diagram of an embodiment of a method for generating a virtual debate by a social networking application.

FIG. 8 is a schematic block diagram of an embodiment of a graphical user interface illustrating tagging of content in a social networking application system.

FIG. 9 is a schematic block diagram of an embodiment of a graphical user interface illustrating a user profile in a social networking application system.

FIG. 10 illustrates a logic flow diagram of an embodiment of a method for generating tags associated with content in a social networking application system.

FIG. 11 illustrates a logic flow diagram of an embodiment of a method for determining a rating history in a user profile in a social networking application system.

FIG. 12 illustrates a logic flow diagram of an embodiment of a method for processing a rating history in a user profile in a social networking application system.

### DETAILED DESCRIPTION

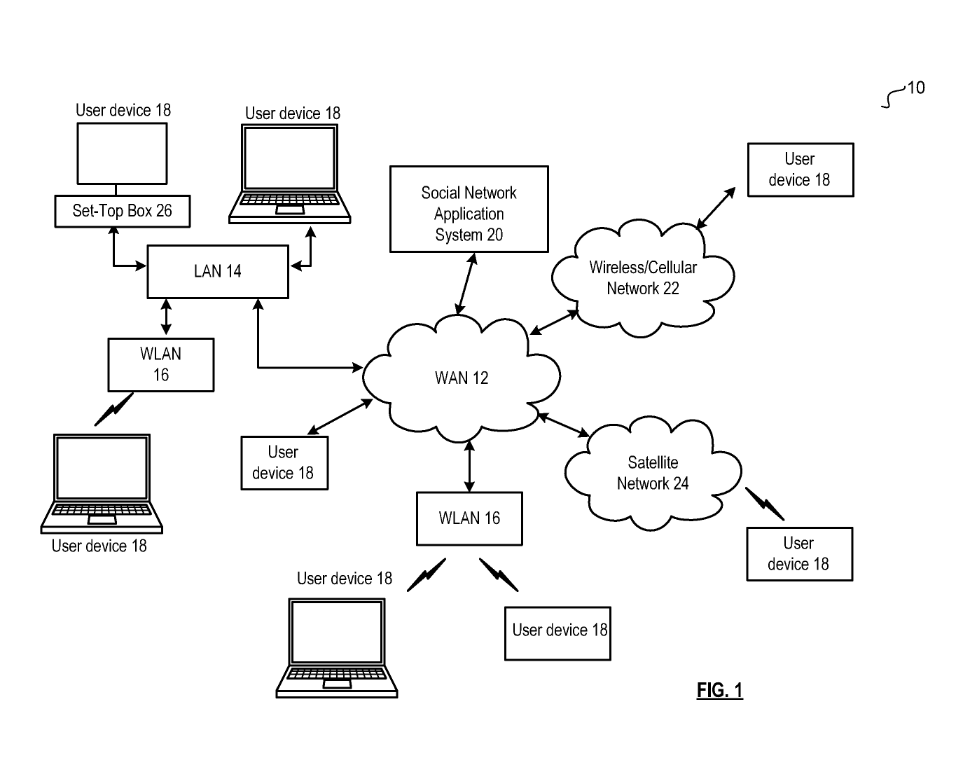

FIG. 1 is a schematic block diagram of an embodiment of network system 10 in which the social network application system 20 operates. The network system 10 includes one or more networks, such as wide area network (WAN) 12, local area network (LAN) 14, wireless local area networks 16, wireless/cellular network 22 and satellite network 24, that are operable to communicate with the social network application system 20. A plurality of user devices 18 are connected to the WAN 12, the WLANs 16, wireless/cellular network 22 and/or satellite network 24. The user devices 18 include, e g., a personal computer, a laptop, a mobile phone, a personal digital assistant, a smart tablet, set top box 26, or other processing device operable with the social network application system 20. In an embodiment, one or more of the user devices 18 are mobile web-enabled devices that are able to operate in a wireless data network, such as a 3G network, EDGE network, GPRS network or WLAN network. In an embodiment, the social network application system 20 may be connected to the WAN 12 through a LAN 14 or WLAN 16 or wireless/cellular network 22.

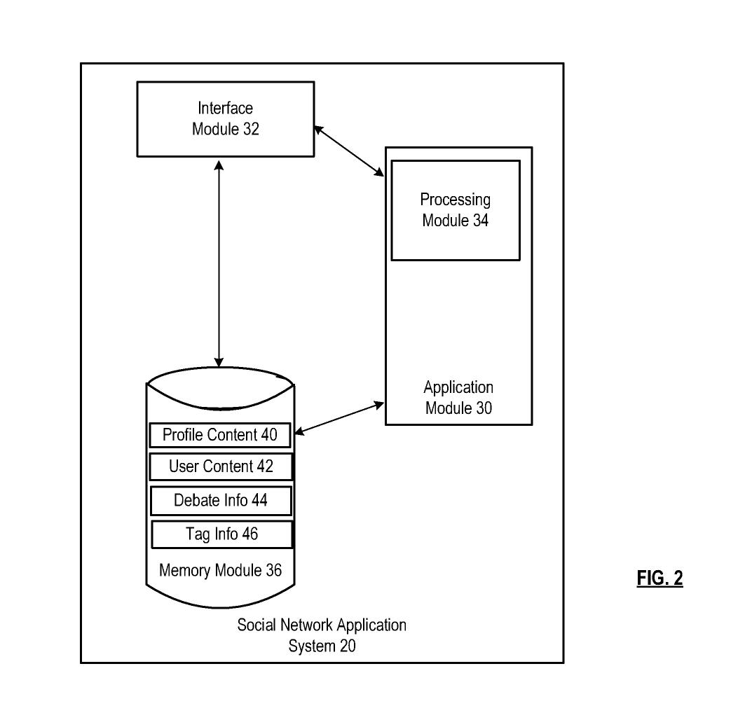

FIG. 2 is a schematic block diagram of an embodiment of the social network application system 20. The social network application system 20 includes an application module 30, an interface module 32, processing module 34 and a memory module 36. The interface module 32 is operable to provide communication or operably couple with the plurality of user devices 18 over WAN 12, LAN 14, WLANs 16, wireless/cellular network 22 and/or satellite network 24. In an embodiment, the interface module 32 includes one or more network cards, web servers or file servers that are operable to communicate using a data transfer protocol, such as Hyper Text Transfer Protocol (HTTP) protocol, File Transfer Protocol (FTP) or other protocol designed to communicate data files, such as Hypertext Markup Language (HTML) files, text, images, audio, videos or other data files to the user devices 18. The interface module 32 may also include authentication capability that requires authentication prior to allowing access to some or all of the resources of the social network application system 20. The interface module 32 may also include firewall, gateway and proxy server functions. The interface module 32 may include other hardware devices or software needed to provide communication between the social network application system 20 and the user devices 18.

In an embodiment, the social network application system 20 also includes one or more application modules 34 operable to perform one or more functions of the social network application system 20 described herein. The application module 30 includes one or more processing modules 34. The social network application system 20 also includes at least one memory module 36. The memory module 36 is operable to communicate with interface module 32 and processing module 34. The memory module 36 includes one or more databases implemented using one or more memory devices, detached memory devices, network attached storage devices, storage area networks, or other memory devices located in one geographical location or multiple geographical locations. The memory module 36 may be structured as relational, network, hierarchal or object based or other type of structured database or document management application operable to store and locate data as described herein.

In an embodiment, the memory module 36 includes logical or physical databases, such as profile content database 40, user content database 42, debate information 44, and tag information 46. The profile content database 40 includes user profile data and location information data. The user content database 42 includes data files uploaded by users to be displayed on their web pages, such as avatars, photos, videos, text, music, etc. The separation of the databases simplifies upgrades and expansion of each database. For example, the user content database 42 may be upgraded or expanded separately from the user profile database 40. In another embodiment, the databases 40 to 46 are not separate logical databases but are combined into one logical or physical database or into a different number of databases. In another embodiment, the memory module 36 includes additional or alternative databases.

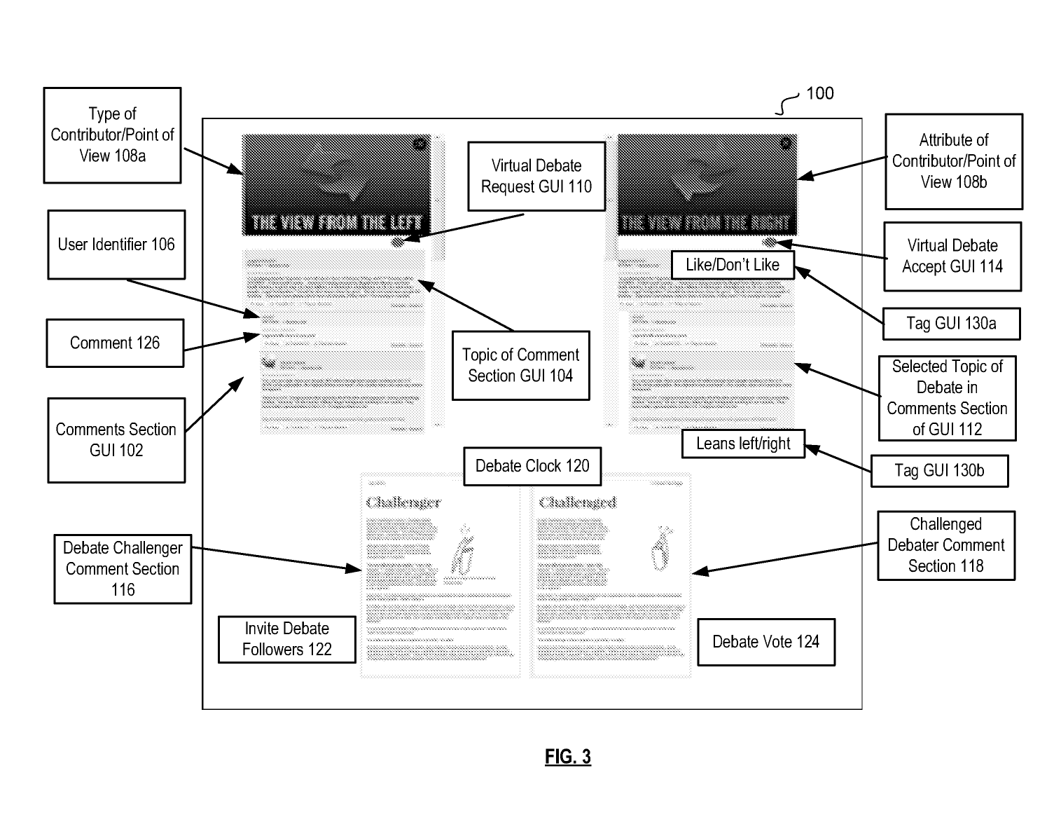

FIG. 3 is a schematic block diagram of an embodiment of a graphical user interface (GUI) 100 of social network application system 20 for multilayer debate and tagging. A graphical user interface or GUI as used herein includes one or more of text, images, hyperlinks, videos, commands, actions and information in an interface allowing users to interact with electronic devices. A GUI may include one or more windows and pop-ups.

The social network system 20 is operable to provide an interactive debate and tagging application system. The graphical user interface 100 is an example embodiment and other graphical user interfaces in one or more windows may be implemented by the social network system providing similar and/or additional functionality by the social network application system 20. The graphical user interface 100 includes one or more comment section GUIs 102. In an embodiment, the social network application system 20 provides a comment section GUI 102 for one or more of a plurality of topics. The plurality of topics may include topics selected from political, social, religious, current news, legal, sports, business, entertainment, medical and/or other fields of interest or a mixture thereof. The comments section GUI 102 includes the topic of the comment section GUI 104.

The social network application system 20 is operable to receive comments from one or more users and post the comments in one or more comment section GUIs 102. The comments received by the social network application system 20 may include text, images, video, voice, hyperlinks or other types of content. The received comments may designate one or more comment section GUIs 102 by topic and may be received via a user device by text or voice. The social network application system 20 is operable to edit or reject the comments. The social network application system 20 displays one or more comments 126 in the designated comment section GUI 102 along with an identifier of the user/contributor 106 of the comment 126. In another embodiment, the social network application system 20 is operable to determine one or more comments section GUIs 102 for display of a comment 126 based on keywords in the comment 126.

In an embodiment, one or more comment section GUIs 102 are designated for a topic and based on a attribute of contributor. For example, one comment section GUI 102 is designated for a political topic and for commenters from a first political party and a comment section GUI 102 is designated for the political topic and for commenters from a second political party. In another example, a medical topic may have one designated comment section GUI 102 for comments by medial professionals and a second designated comment section GUI 102 for comments by patients or nonmedical professionals. As such, one or more comments section GUI 102 may be designated for a plurality of topics. The one or more comments section GUIS 102 are designated for one of more attributes of contributors. The comments section GUI 102 includes the topic of the comment section GUI 104 and the one or more attributes of contributors 108 designated for the comment section GUI 104.

In another embodiment, one or more comment section GUIs 102 are designated for a topic and based on a point of view. For example, a first comment section GUI 102 is designated for a topic of a proposed law or candidate and for comments supporting the proposed law or candidate and a second comment section GUI 102 is designated for the topic of a proposed law or candidate and for comments not supporting the proposed law or candidate. A third comment section GUI 102 may be designated for the topic of a proposed law or candidate and for comments undecided or partially supporting the proposed law or candidate. In another example, one designated comment section GUI 102 is for a medical topic on legalization of a substance and comments supporting legalization and a second designated comment section GUI 102 for comments not supporting legalization of the substance. As such, one or more comments section GUIs 102 are designated for a topic with each of the comments section GUIS 102 designated for one of a plurality of points of view on the topic. The comments section GUI 102 includes the topic of the comment section GUI 104 and the point of view 108 for the comment section GUI 104.

In another embodiment, a comment section GUI 102 is designated for a plurality of related topics, such as freedom of speech and assembly. A comment section GUI 102 designated to a topic or plurality of topics may then also be designated for one or more plurality of points of view and/or one or more attributes of contributors 108.

In an embodiment, the social network application system 20 receives a request to post a comment that includes at least a user identifier 106 of the contributor of the comment. The request may also include a requested comment section GUI 102 to post the submitted comment. In another embodiment, the social network application system 20 is operable to determine one or more comments section GUIs 102 for display of a comment 126 based on keywords in the comment 126 and based on information in user profiles. For example, the social network application system 20 determines from keywords in the comment a topic of the comment, such as a political presidential race. The social network application system 20 is also operable to access a user profile database of the contributor of the comment and determine contributor attributes. For example, the social network application system 20 determines that the contributor is part of a particular political party from the contributor's user profile. The social network application system 20 then determines one or more comment section GUIs 102 to post the comment based on key words in the comment and contributor attributes from the user profile. For example, the social network system 20 determines to post the comment in comment section GUIS 102 with topics relating to the presidential race and designated for contributors belonging to the particular political party of the contributor.

In another embodiment, the social network application system 20 is operable to provide one or more other mechanisms for a contributor to tag their comments. The social network application system 20 provides a tag GUI 130 to indicate support or opposition to a topic in the comment section GUI 102 or to a particular comment 126 in a social network application system. A contributor of a comment may tag their own comment 126. A tag GUI 130 may indicate a point of view of the topic, such as support of a topic or comment, or the tag may indicate an attribute of the contributor (such as political party, age, religious affiliation, etc.). For example, tag 130a indicates a point of view of like/don't like of a comment. Tag 130b indicates a point of view of leans left or leans right, e.g. the user feels the comment leans politically right or politically left. The social network application system 20 allows users to tag comments 126 with their point of view using the Tag GUI 130.

The social network application system 20 is operable to determine various statistics about a topic of a comment section GUI 102 based on comments and attributes of contributors. For example, the social network application system 20 may determine that a certain percentage of a political party favor a topic or persons over 60 feel unfavorably about a topic or a certain percentage of women in a certain income bracket support a candidate, etc.

The social network application system 20 is operable to provide a platform for a virtual debate between users. The social network application system 20 includes a virtual debate request GUI 110. When a virtual debate is requested, the social network application is operable to identify a user requesting the debate, e.g. debate challenger. The debate challenger provides an identifier of one or more requested challenged debaters and a topic of the debate. In an embodiment, a comment 126 in the comments section GUI 102 is highlighted or selected by the debate challenger as a selected topic of debate 112. The user posting the comment is identified by the social network application system as the requested challenged debater. For example, upon finding a comment 126 to challenge, a user highlights the comment 126 (e.g., by double clicking it with a left button input device (mouse)) to designate it as the selected topic of debate 112 and selects the virtual debate request GUI 110. The social network application system 20 determines that the selected comment is the topic of the debate and the contributor of the selected comment is the requested challenged debater. In another embodiment, the virtual debate request GUI 110 provides an input form or a selection mechanism to input or select a debate topic and requested challenged debater.

Upon receiving a virtual debate request, the social network application system 20 is operable to initiate a debate challenge request to the one or more requested challenged debaters. The debate challenge Irequest may be sent using one or more types of notifications including a phone text, email, twitter, posting on another social network application, Instant Messaging and posting on a user's profile and/or internal message board in the social network application. The social network application system 20 is operable to receive a virtual debate acceptance, e.g. by receiving a selection of the virtual debate accept GUI 114 or through a phone text, email, IM, etc. After acceptance of a virtual debate by the participants, the social network application system 20 is operable to generate a debate GUI including a debate challenger comment section 116 and one or more challenged debater comment sections 118. In another embodiment, a single virtual debate section is presented for entering comments by both the debate challenger and challenged debater.

The social network application system 20 is operable to provide default debate rules for the virtual debate. In another embodiment, selected rules may be proposed and agreed upon by the debate participants using the social network application system. For example, a timed debate lasting a predetermined time period, such as 1 hour, 1 day or 1 week is initiated. A debate clock GUI 120 is presented in the virtual debate GUI to track time based on the terms agreed upon by the virtual debate participants. For example, the social network application system 20 presents several options, such as “total debate time”, “total time per response” and other time related options to the virtual debate participants. In another embodiment, a debate without time constraints is selected.

The social network application system 20 is operable to provide an Invite Debate Followers GUI 122. The social network application system 20 receives requests to invite one or more debate followers from one or more of the debate participants. The debate follower request is transmitted by the social network application system 20 using one or more types of notifications including a phone text, email, twitter, posting on another social network application, Instant Messaging and posting on a user's profile and/or internal message board provided by the social network application system 20. The debate participants post comments including text inputs, voice inputs, video inputs, hyperlinks, or other content that are displayed to the debate followers or, if authorized under debate rules, to other users by the social network application system 20.

The social network application system 20 is operable to provide a debate vote GUI 124. The debate vote GUI 124 provides a mechanism to vote for a debate comment posted by one or more of the debate participants or for an overall debate winner. Voting may be restricted by the social network application system 20 to only invited debate followers or may be open to any user. The social network system application 20 is operable to display one or more vote tallies, such as vote tallies for debate comments and overall debate winner.

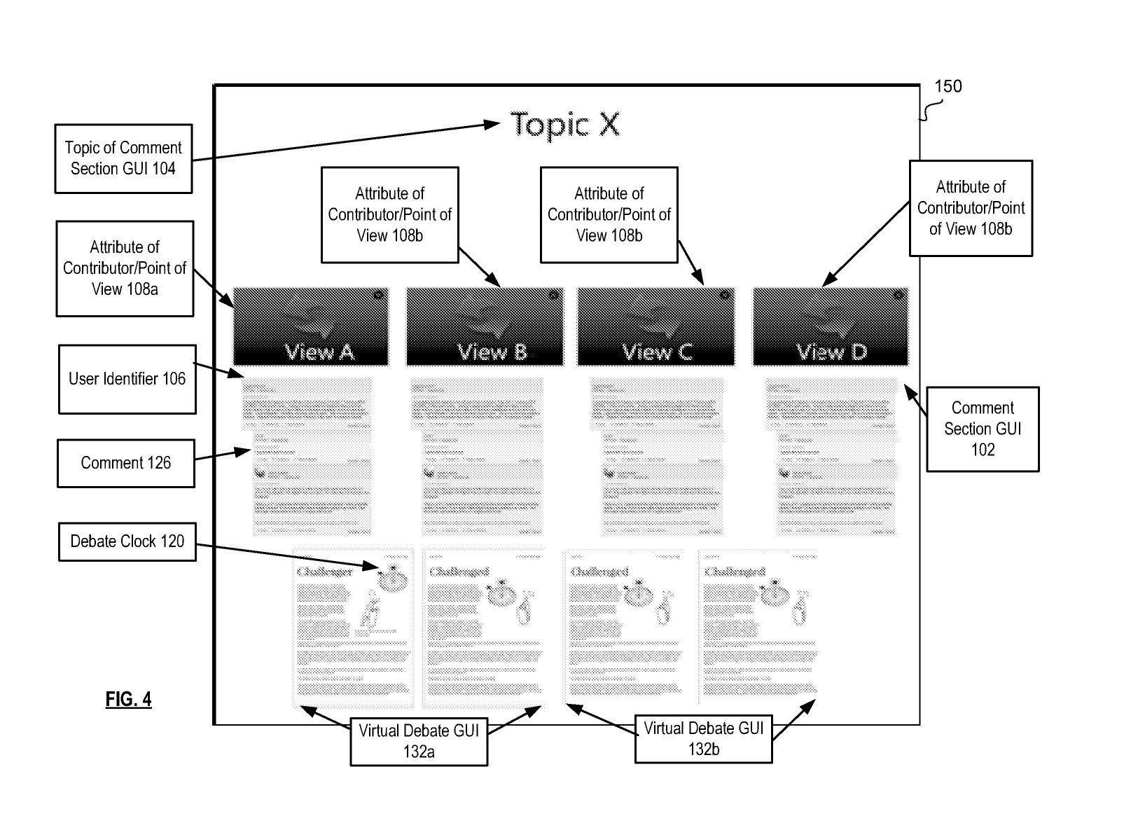

FIG. 4 is a schematic block diagram of another embodiment of a graphical user interface (GUI) 150 of social network application system 20 for multilayer debate and tagging. The graphical user interface 150 is an example embodiment and other graphical user interfaces in one or more windows may be implemented by the social network system providing similar and/or additional functionality by the social network application system 20. The graphical user interface 150 includes a plurality of comment section GUIs 102. A topic 104 of the comment section GUIs is illustrated on the GUI 150. The comment section GUIs 102 depict an attribute of contributor/point of view 108a and 108b. For example, one or more of the plurality of comment section GUIs 102 with a same topic are designate with a different point of view or contributor attribute 108 for the topic 104. For example, one comment section GUI 102 is designated for a contributor attribute of females from a first political party and a point of view of in favor of the topic while another comment section GUI 102 is designated for a contributor attribute of males from a second political party with a point of view of not supporting the topic. Any combination of one or more contributor attributes and one or more points of view may be designated for a comment section GUI 102. In addition, as seen in FIG. 4, the GUI 150 depicts a plurality of virtual debate GUIs 132a and 132b related to the topic.

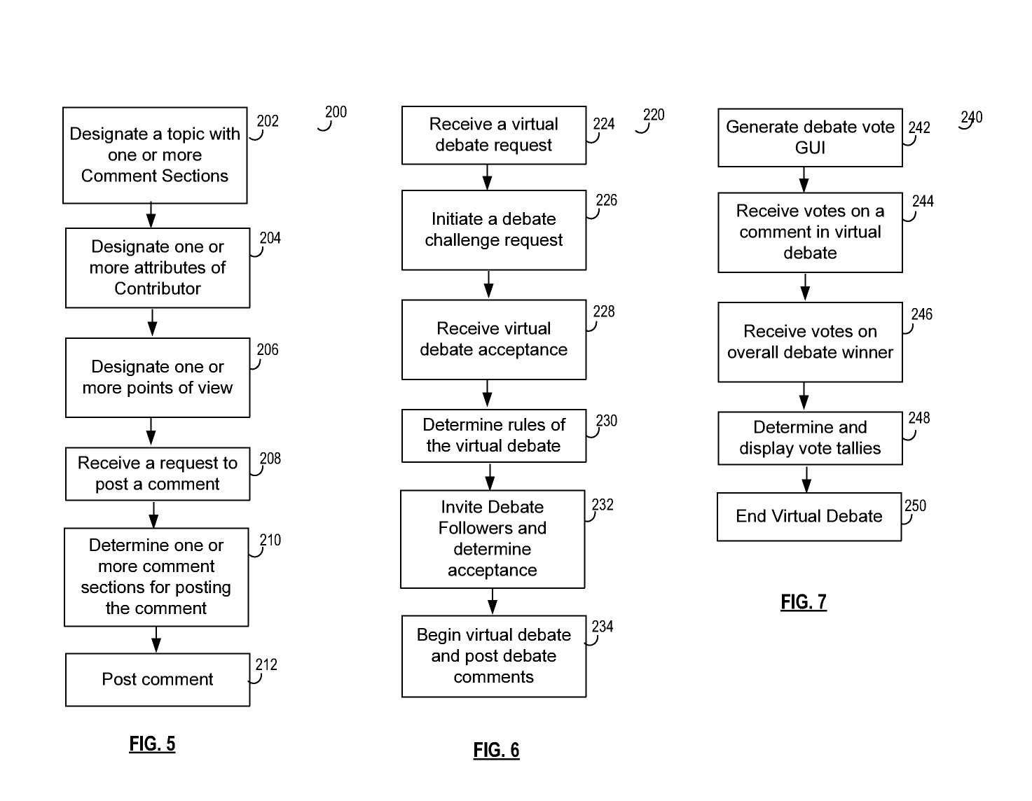

FIG. 5 illustrates a logic flow diagram of an embodiment of a method 200 for providing a comment section GUI 102 by a social networking application system 20. Social network application system 20 using application module 30, interface module 32 and memory module 36 and other necessary devices is operable to perform the steps described herein. In step 202, social network application system 20 designates a topic and generates one or more comment section GUIs 102 for the topic. The topic may be generated by a system administrator or input from a system user. For each of the comment section GUIs 102 of a topic, the system network application system 20 determines whether to designate one or more attributes of a contributor to the comment section GUI 102 in step 204. In step 206, the system network application system 20 determines whether to designate one or more points of view to the comment section GUIs 102 of a topic. In step 208, the system network application system 20 receives a request to post a comment from a user device 18. The comment includes at least a user identifier 106 of the contributor of the comment.

The system network application system 20 determines one or more comment section GUIs 102 to post the received comment. In an embodiment, the request may also include a requested comment section GUI 102 to post the submitted comment, e.g. the user highlights or selects a comment section GUI 102 such as from GUI 100 or GUI 150 and submits a comment via the selected comment section GUI 102. In another embodiment, the social network application system 20 is operable to determine one or more comment section GUIs 102 to post a comment 126 based on keywords in the comment 126 and based on contributor attributes in the user profile. The social network application system 20 may also determine one or more comment section GUIs 102 to post a comment 126 based on tags given to the comment from the contributor or others as described herein. The social network application system 20 thus determines one or more comment section GUIs 102 to post the comment. In step 212, the social network application system 20 posts the comment in the one or more determined comment section GUIs 102.

FIG. 6 illustrates a logic flow diagram of an embodiment of a method for initiating a virtual debate by a social networking application. In step 224, social network application system 20 receives a request for a virtual debate from one or more debate challengers. The request includes one or more challenged debaters. In step 226, the social network application system 20 initiates a debate challenge request to the one or more challenged debaters. The social network application system 20 receives acceptance of a virtual debate from one or more challenged debaters in step 228 and determines rules of the virtual debate in step 230. The rules of the virtual debate may be set to default rules or altered by agreement of the debaters. For example, the rules of the virtual debate may specify a predetermined start and end time to the debate, predetermined number of comments by each debater, number of words in comments by the debaters, length of time to respond by posting a comment by a debater, order of comments by the debaters, etc. In step 232, the social network application system 20 is operable to receive requests to initiate invitations to other users to follow of the debate. The requests may be from debate challengers, challenged debaters or followers of the debate. The social network application system 20 transmits invitations to the debate followers and determines their acceptance. In step 234, social network application system 20, initiates a virtual debate GUI and posts comments from the debate challengers and challenged debaters.

FIG. 7 illustrates a logic flow diagram of an embodiment of a method for generating a virtual debate by a social networking application 20. In step 242, social networking application 20 is operable to generate one or more debate vote GUIs 124. The debate vote GUI 124 provides a mechanism for debate followers to vote for an individual comment in a virtual debate or an overall debate winner among the debate challengers and challenged debaters. In step 244, the social networking application 20 receives votes for one or more comments in the virtual debate. In step 246, social networking application 20 receives votes on an overall debate winner. Voting may be restricted by the social network application system 20 to only invited debate followers or may be open to any user of the social networking application system 20. In step 248, the social network system application 20 is operable to determine and display one or more vote tallies, such as vote tallies for debate comments and overall debate winner. In step 250, the virtual debate ends. The virtual debate may end after a predetermined expiration of time set in the rules of the virtual debate or after a predetermined number of comments or a combination thereof.

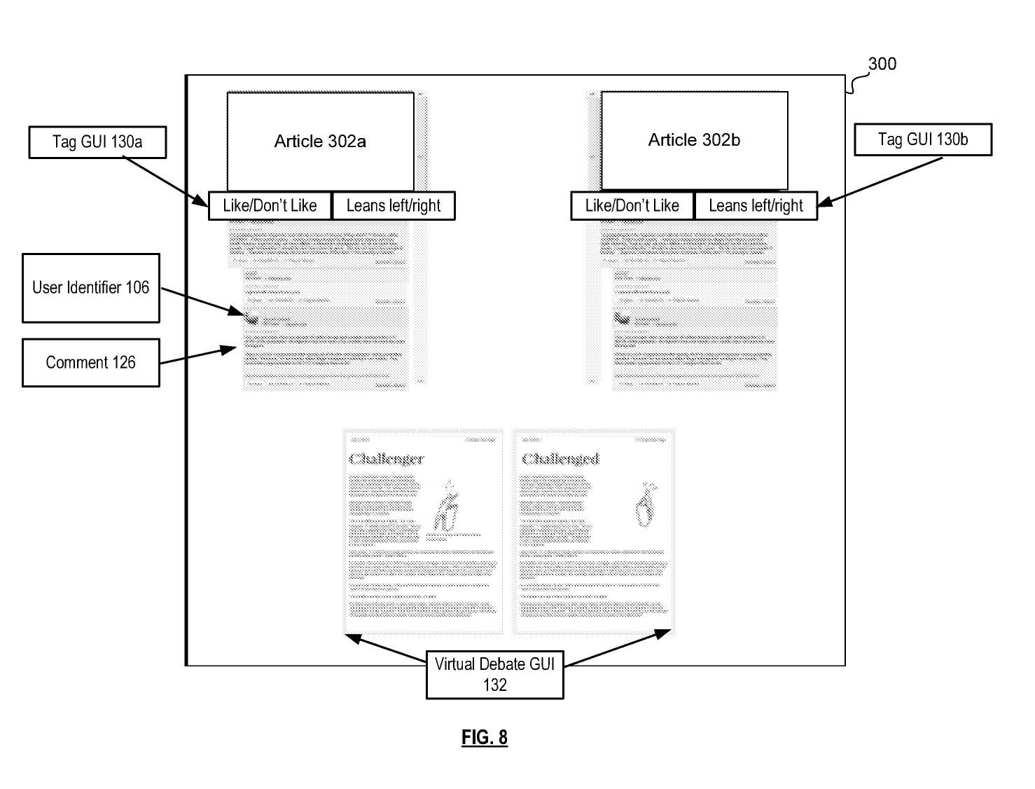

FIG. 8 is a schematic block diagram of an embodiment of a graphical user interface 300 illustrating tagging of content in a social networking application system 20. The social networking application system 20 is operable to generate one or more Tag GUIs 130 associated with content displayed or generated in GUIs by the social networking application system 20. The tagged content includes articles 302 (such as news articles or editorials), images, public figures, issues, videos, or comments 126 by users or comments by debaters in a virtual debate. The social networking application system 20 assigns a Tag GUI 130 to content for users to select one or more options. The vote tally for the options in the Tag GUI 130 is determined and may be displayed as well.

A Tag GUI 130 may be assigned from one or more categories and include one or more options. For example, Tag GUI 130a is associated with Article 302a and is assigned to a point of view category with options of LIKE/DON'T LIKE. When a user selects an option from Tag GUI 130a, the social networking application system 20 receives the selection from the Tag GUI 130a of whether a user likes or does not like Article 302a along with the user's identifier 106. In another example, Tag GUI 130b is assigned to a political category with options of “Leans Left” or “Leans Right.” When a user selects an option from Tag GUI 130b, the social networking application system 20 receives the selection from the Tag GUI 130a of whether the user feels Article 302b “leans left” or “leans right” along with the user's identifier 106. Other tag options in a political category include “independent”, “libertarian”, “green party,” etc. In a religious category, a tag options may include Christian, Atheist, Agnostic, etc. In a point of view category, tag options include like, don't like, support, don't support, unsure, etc. Tag GUIs 130 may include other options in other categories, such as political, religious, sports, entertainment, social or other categories or leanings of persuasion.

FIG. 9 illustrates a schematic block diagram of an embodiment of graphical user interface 350 illustrating information in a user profile 352 in a social networking application system 20. The user profile 352 includes user identifier 106 and display options 356. The user profile 352 also includes a cumulative rating history 354. The social networking application system 20 determines the rating history 354 using tag information of content related to the user. For example, the social networking application system 20 uses tag information of content posted by the user, such as percentage of “leans right” or “leans left” votes received by a Tag GUI 130 of the content. In another example, the social networking application system 20 uses tag information of content indicated as “Like” or “Support” by the user. For example, the social networking application system 20 uses information that a user “likes” an article that has a percentage of “leans right” tag votes. In another example, when a user places a vote tag using a Tag GUI 130 of “Support” for a Republican candidate, the social networking application system uses this information. The user profile 352 then presents in numerical and/or graphical form, a rating history 354 for the user based on this tag information of content related to the user. The rating history 354 illustrates a percentage of content “liked” by the user that leans right or leans left or leans libertarian, etc.

In another embodiment, the user profile 352 assigns a type of badge or indicator to a user using tag information of content related to the user. For example, a rank or badge as a “liberal”, “conservative”, “libertarian”, “environmentalist”, “feminist”, etc. is assigned to a user profile when a certain percentage and/or length of history indicates such rank or badge. In another embodiment, a scale or percentage is assigned to a user profile based on tag information of content related to the user, such as an 8 out of a scale of 1-10 as having conservative or liberal political views.

User profile 352 includes one or more content collections 360a. The social networking application system 20 is operable to generate a folder or GUI upon request by a user and called herein content collection 360. The content collection 360 is operable to store content requested by a user. For example, a user may cut and paste content, such as hyperlinks, text, images or other content, to the content collection or add text in text comment or text boxes in content collection 360. For example, content collection 360a includes content related to economic recovery while content collection 360b includes content related to global warming. The social networking application system 20 is operable to perform upon request a cut and paste of content from a content collection 360 or hyperlink to content in a content collection 360 to a comment 126 in a virtual debate GUI 132 or in a comment section GUI 102.

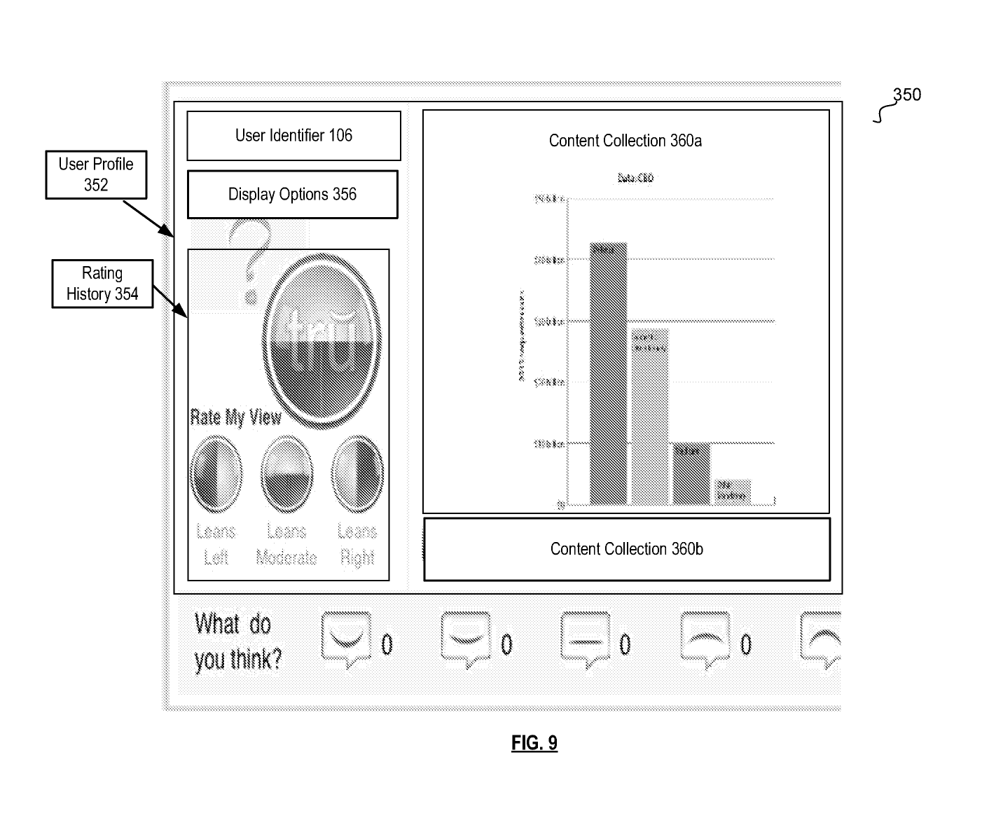

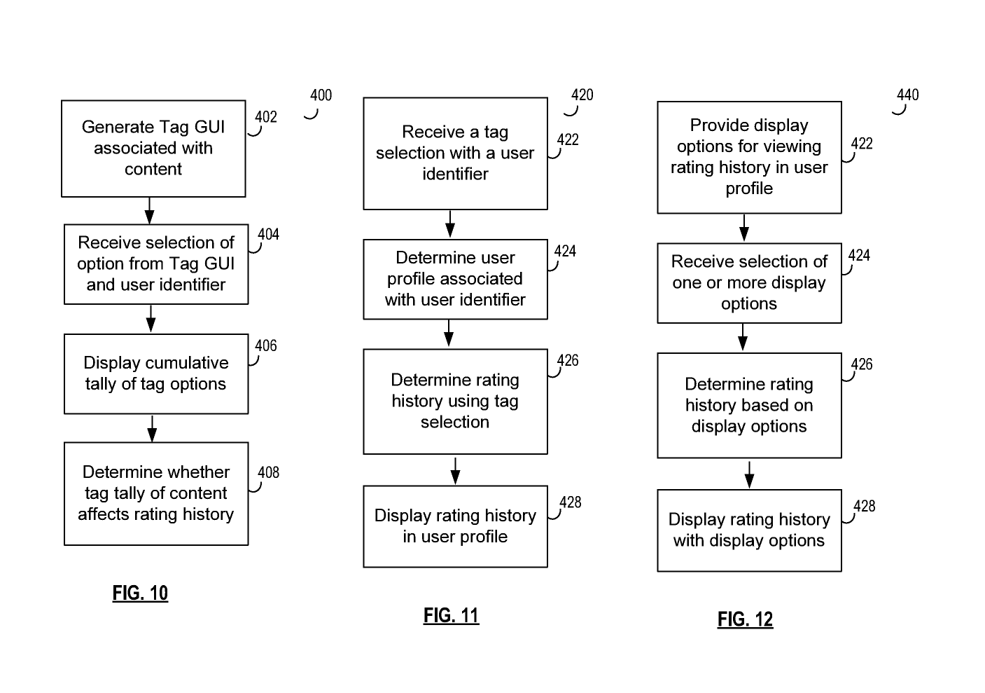

FIG. 10 illustrates a logic flow diagram of an embodiment of a method 400 for generating tags associated with content in a social networking application system 20. In step 402, based on type of content, the social networking application system 20 generates one or more Tag GUIs 130 associated with the content displayed by or generated in a GUI of the social networking application system 20. The social networking application system 20 in an embodiment generally assigns at least one TAG GUI 130 that includes a point of view category including such options as “Like”, “Don't Like”, “Support”, “Not Support”, “Unsure”, etc. In an embodiment, the social networking application system 20 generally assigns at least another TAG GUI 130 that includes a political category including such options as “Leans Right”, “Leans Left”, “Liberal”, “Conservative”, “Libertarian”, etc. In step 404, the social networking application system 20 receives a selection of an option of a TAG GUI 130. The selection of the option includes a user identifier as well. The social networking application system 20 displays a tally of tag options selected by users in step 406. For example, the social networking application system 20 displays 50% “Like” the content and 45% vote the content “Leans Right”, 45% vote the content “Leans Left” and 5% vote “Unsure”.

In step 408, the social networking application system 20 may determine whether the tally of tag options associated with the content affects a rating history. For example, the tally may affect the rating history of the contributor of the content. In another example, the content may relate to a candidate's statements, and the tally of tag options may thus affect a rating history of the candidate. For example, the social networking application system 20 is operable to track voting of tag options such as “Leans Right” or “Leans Left” of content associated with a political figure (such as news articles about or statements of the political figure) and track a rating history of the political figure as “Leaning Right” or “Leaning Left” or determining a rank or scale of having liberal or conservative political views based on the tag tallies of the content.

FIG. 11 illustrates a logic flow diagram of an embodiment of a method 420 for determining a rating history in a user profile in a social networking application system 20. In step 422, social networking application system 20 receives a selection of an option of a Tag GUI 130 and a user identifier. In step 424, the social networking application system 20 determines a user profile associated with the user identifier. When the tag option selection includes a point of view, such as “Like”, “Don't Like”, “Support”, “Not Support”, “Unsure”, the social networking application system 20 determines whether the content has another Tag GUI 130 associated with another category, such as political, social, religious, etc. and any vote tallies associated with the other categories. If so, the social networking application system 20 determines a rating history using the tag selection. For example, if the another category is political, the social networking application system 20 determines the tally of tag options, such as “Leaning Right” or “Leaning Left” and determines a rank or scale of having liberal or conservative political views based on the tag tallies of the content and the point of view of the content by the user. The social networking application system 20 is thus operable to determine a rating history 354 using tag information of content related to the user in step 426. In step 428, the social networking application system 20 displays the rating history in the user profile 352.

FIG. 12 illustrates a logic flow diagram of an embodiment of a method 440 for processing a rating history in a user profile in a social networking application system 20. In step 422, the social networking application system 20 generates display options 356 for rating history 354 in a user profile 352. The display options include, for example, time periods, keywords, categories, etc. For example, the display options may include a time period to display a rating history 354 of political views such that a person may determine their political leanings during a period of time. The options may include a keyword search of content so that a rating history 354 based on content with those key words is displayed, e.g. a keyword search of content with “global warming”. The options may include a rating history 354 of content contributed by the user. Other options may be presented as well. In step 424, the social networking application system 20 receives a selection of one or more display options, and in step 426, determines rating history based on display options. In step 428, social networking application system 20 displays the rating history 354 with the one or more display options.

The social network system 20 is operable to provide an interactive debate and tagging application system. In an embodiment, the social network application system 20 provides a comment section GUI 102 for posting comments on content and a virtual debate system. The social network application system 20 is operable to associate tags with content and provide a rating history based on tag selections of content related to the user in a user profile.

The social network application system 20 is described, at least in part, in terms of one or more embodiments. An embodiment is used herein to illustrate the social network application system 20, an aspect thereof, a feature thereof, a concept thereof, and/or an example thereof. A physical embodiment of an apparatus, an article of manufacture, a machine, and/or of a process that embodies the social network application system 20 may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones in a same or different order or arrangement.

The term “module” is used in the description of the various embodiments of the present invention. A module includes a processing module, a functional block, or other hardware as well as software stored on memory for performing one or more functions as may be described herein. The hardware may operate independently and/or in conjunction with software and/or firmware. As used herein, a module may contain one or more sub-modules, each of which may be one or more modules. As may also be used herein, the terms “processing module”, “processing circuit”, and/or “processing unit” includes a single hardware processing device or a plurality of hardware processing devices. Such a processing device may be a microprocessor, micro-controller, digital signal processor, microcomputer, central processing unit, field programmable gate array, programmable logic device, state machine, logic circuitry, analog circuitry, digital circuitry, and/or any hardware device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A social networking application system, comprising:
a memory module for storing user profiles for a plurality of users of the social networking application;
a processing module operable to:
generate a display of a comment on a topic by a first user of the plurality of users;
receive a request for a debate on the comment on the topic;
when a debate is accepted by the first user and at least a second user, provide a graphical user interface to display the debate by the first and second user.

2. The system of claim 1, wherein the processing module is further operable to:
determine debate rules for the debate inputs by the first and second user.

3. The system of claim 1, wherein the processing module is further operable to:
collect votes input to the social networking application system from a plurality of other users on the debate by the first user and second user; and
determine whether the first user or the second user has received a majority of the collected votes.

4. A social networking application system, comprising:
a memory module for storing user profiles for a plurality of users of the social networking application;
a processing module operable to:
generate application content for display to the plurality of users;
receive an input to the application content that includes one of a plurality of pre- determined categories;
provide a rating in the predetermined categories of at least one of the application content ,content writer, content commenter based on the collected inputs.

5. The system of claim 4, wherein the processing module is further operable to:
provide a cumulative history of ratings in the predetermined categories of a user and/or data content by the users.
